(19) United States
(12) Patent Application Publication
(10) Pub. No.: US 2020/0395792 A1
(43) Pub. Date: Dec. 17, 2020

(54) PHOTOVOLTAIC MODULE DEVICE

(71) Applicant: MITSUBISHI HEAVY INDUSTRIES, LTD., Tokyo (JP)

(72) Inventors: Nozomi HARA, Tokyo (JP); Hideki TONAKA, Tokyo (JP)

(21) Appl. No.: 16/787,224

(22) Filed: Feb. 11, 2020

(30) Foreign Application Priority Data
Jun. 17, 2019 (JP) 2019-112040

(51) Int. Cl. H02J 50/30; H05B 47/115; H02J 50/90; H02J 50/40

(52) U.S. Cl. CPC H02J 50/30; H02J 50/40; H02J 50/90; H05B 47/115

(57) ABSTRACT

What is provided is a photovoltaic module device which is configured to supply electric power to a first target device installed on a rotating body which is rotationally driven, in which a plurality of photovoltaic cells constituting a photovoltaic cell column are connected to configure a parallel circuit, and a plurality of photovoltaic cell columns are disposed in an axial direction with positions of seam portions thereof in a circumferential direction of the rotating body deviated from each other.

### BACKGROUND OF THE INVENTION

### Field of the Invention

The present invention relates to a photovoltaic module device.

Priority is claimed on Japanese Patent Application No. 2019-112040, filed on Jun. 17, 2019, the content of which is incorporated herein by reference.

### Description of Related Art

Patent Document 1 discloses a telemeter device which measures a physical quantity such as an axial torque or a temperature of a rotating body that is an object to be measured using a detector attached to the rotating body and transmits a signal indicating the measured physical quantity to a receiving unit.

The telemeter device includes a photovoltaic module device which supplies electric power to a target device installed on the rotating body.

The photovoltaic module includes a photovoltaic cell group formed of a plurality of photovoltaic cells disposed in a circumferential direction and axial direction of the rotating body and configured to generate electric power by being irradiated with light, and an illuminator (light source) which irradiates the photovoltaic cell group with light.

### PATENT DOCUMENTS

Patent Document 1: Japanese Unexamined Patent Application, First Publication No. H05-120593

### SUMMARY OF THE INVENTION

Incidentally, a photovoltaic module is configured such that photovoltaic cells disposed adjacent to each other in a circumferential direction and axial direction are connected in parallel (circumferential direction) and in series (axial direction), but the light energy cannot be converted into electric power at seam portions of the photovoltaic cells even when light energy is supplied as a matter of course.

That is, in a relationship between a photovoltaic cell group that generates electric power by being irradiated with light and an illuminator (light source) that irradiates the photovoltaic cell group with light, portions that generate electric power (photovoltaic cells) and portions that do not generate electric power (seam portions) are alternately disposed with respect to circumferential movement of the rotating body.

When the seam portions of the plurality of photovoltaic cells disposed in a circumferential direction are disposed to be aligned in an axial direction as in Patent Document 1, there are problems as below. That is, pulsation in electric power output from the photovoltaic cell group occurs due to a difference between electric power generated when there are seam portions disposed in a circumferential direction and electric power generated when there is no seam portion (when only photovoltaic cells are irradiated with light) in a light irradiation region irradiated with light.

As an extreme example, when a circumferential position in which no photovoltaic cell is present and a circumferential position in which a photovoltaic cell is fully illuminated are alternately disposed in a light irradiation region irradiated with light, an output in a form of a half-wave rectified waveform will be obtained.

Therefore, it is necessary to provide a smoothing circuit for minimizing pulsation of electric power and a charging circuit for stabilizing supplied electric power.

Also, when efficiency in electric power generation of photovoltaic cells is considered, generally, it is advantageous to increase an output voltage, and in the example described in Patent Document 1, a voltage increases when the number of columns of photovoltaic cells disposed to be aligned in an axial direction is increased. However, when there is a configuration to output a voltage higher than an operating voltage of a target device to which electric power is supplied, a voltage conversion circuit is necessary.

Therefore, an objective of the present invention is to provide a photovoltaic module device in which pulsation of electric power can be minimized without providing a smoothing circuit, a charging circuit, a voltage conversion circuit, or the like.

In order to solve the above-described problems, according to a photovoltaic module device according to one aspect of the present invention, the photovoltaic module device which is configured to supply electric power to a target device installed on a rotating body which is rotationally driven includes a photovoltaic cell column group installed on a circumferential surface of the rotating body, and a light source fixed at a position away from the rotating body and configured to irradiate the photovoltaic cell column group which is configured to rotate together with the rotating body with light, in which the photovoltaic cell column group includes two photovoltaic cell columns which are disposed in a circumferential direction of the rotating body, which are configured by alternately disposing photovoltaic cells and seam portions in the circumferential direction, and in which a plurality of the photovoltaic cells are connected in parallel, the two photovoltaic cell columns are disposed at positions adjacent to each other in an axial direction of the rotating body, and the seam portions of the two photovoltaic cell columns are disposed in the axial direction with positions thereof in the circumferential direction deviated from each other.

According to the present invention, when the seam portions are disposed in the axial direction with positions in the circumferential direction of the seam portions constituting two photovoltaic cell columns deviated from each other, a magnitude of pulsation of generated electric power can be reduced compared to a case in which two photovoltaic cell columns are disposed with the seam portions thereof aligned in the axial direction.

Thereby, when a disposition in the circumferential direction of the seam portions constituting the two photovoltaic cell columns is changed, pulsation of electric power can easily be minimized without providing a smoothing circuit.

Also, with the above-described configuration, pulsation of electric power can be adjusted to be within a variation range of an operating voltage allowed by the target device to which the electric power is supplied. Thereby, since a charging circuit for stabilizing electric power is not necessary, a configuration of the photovoltaic module device can be simplified.

Further, since a voltage conversion circuit also is not necessary when unit cells are configured to correspond to an operating voltage of the target device in advance, the configuration of the photovoltaic module device can be simplified.

In the photovoltaic module device according to one aspect of the present invention, the light source may irradiate a partial region of the photovoltaic cell column group with light, the photovoltaic cell column group may output an operating voltage corresponding to a target device to which electric power is supplied when the partial region thereof is irradiated with light, and the two photovoltaic cell columns may be connected in parallel.

As described above, when the two photovoltaic cell columns are connected in parallel and a partial region of the photovoltaic cell column group is irradiated with light, an operating voltage corresponding to the target device to which electric power is supplied can be output.

In the photovoltaic module device according to one aspect of the present invention, the photovoltaic cell columns may each be constituted by a plurality of unit cells, the plurality of unit cells may each be constituted by a portion of the plurality of photovoltaic cells, and the plurality of unit cells may be disposed in the circumferential direction of the rotating body.

As described above, when the plurality of unit cells are each configured by a portion of the plurality of photovoltaic cells and the plurality of unit cells are disposed in series, the photovoltaic cells corresponding to an operating voltage of the target device can be configured. Accordingly, since it is not necessary to provide a voltage conversion circuit, the configuration of the photovoltaic module device can be simplified.

In the photovoltaic module device according to one aspect of the present invention, the plurality of unit cells may each have a backflow prevention device.

As described above, when the plurality of unit cells each have a backflow prevention device, electric power generated in one of the unit cells flowing to another unit cell can be inhibited. Thereby, electric power generated in one of the unit cells (electric power corresponding to the electric power required for driving the target device) can be supplied to the target device.

In the photovoltaic module device according to one aspect of the present invention, the target device may include a first target device driven by a first electric power, and a second target device driven by a second electric power different from the first electric power, the photovoltaic cell column group may include a first photovoltaic cell column constituted by a plurality of first unit cells disposed in the circumferential direction, and a second photovoltaic cell column constituted by a plurality of second unit cells disposed in the circumferential direction and each disposed at a position adjacent to one of the first unit cells in the axial direction of the rotating body, and the light source may include a first light source which is configured to irradiate one of the first unit cells with light, and a second light source which is configured to irradiate one of third unit cells constituted by one of each of the first and second unit cells in the axial direction of the rotating body with light.

As described above, when the first and second photovoltaic cell columns and the first and second light sources having the above-described configurations are provided, necessary electric power can be supplied to the respective first and second target devices while minimizing pulsation of the electric power without providing a smoothing circuit.

In order to solve the above-described problems, according to a photovoltaic module device according to one aspect of the present invention, the photovoltaic module device which is configured to supply electric power to a target device installed on a rotating body which is rotationally driven includes a photovoltaic cell column installed on an outer circumferential surface of the rotating body and including a plurality of unit cells, and a light source fixed at a position away from the rotating body and configured to irradiate the photovoltaic cell column which is configured to rotate together with the rotating body with light, in which the photovoltaic cell column is disposed in a circumferential direction of the rotating body, the unit cells are each configured by serially disposing the necessary number of photovoltaic cells required to generate electric power for driving the target device, and the light source is configured to irradiate a region corresponding to only one of the unit cells with light.

According to the present invention, when the unit cells are each configured by serially disposing the necessary number of photovoltaic cells required to generate electric power for driving the target device, and a region corresponding to only one of the unit cells is irradiated with light, electric power corresponding to the electric power required for the target device can be stably generated. Thereby, pulsation of electric power can be minimized without providing a smoothing circuit.

Also, since an output voltage does not become a high voltage (a voltage higher than the voltage required for the target device), necessity for a conversion circuit can be minimized.

In the photovoltaic module device according to one aspect of the present invention, a plurality of first target devices having the same operating voltage as each other may be provided as the target device, first light sources of the same number as the number of the first target devices may be provided as the light source, and the first light sources of the same number as the number of the first target devices may irradiate different unit cells of the photovoltaic cell column with light.

With such a configuration, a required drive voltage can be supplied to the respective target devices without increasing the number of photovoltaic cell columns.

The photovoltaic module device according to one aspect of the present invention may further include a tachometer which is configured to acquire a rotation pulse signal of the rotating body during rotational driving, a storage unit which is configured to store a first data indicating a relationship between an intensity of light irradiated from the light source and an amount of electric power output from the photovoltaic cell column, and a second data indicating a relationship between a rotation phase of the rotating body and an amount of electric power output from the photovoltaic cell column, and a control device including a light intensity control unit which is configured to control an intensity of light irradiated from the light source on the basis of the rotation phase of the rotating body, the first data, and the second data, in which the light intensity control unit may control an intensity of light irradiated from the light source to obtain an amount of electric power required for the target device.

As described above, when the tachometer and the control device having the above-described configuration are provided, an amount of electric power required for the target device can be obtained without needing an electric power meter all the time. Also, since the control is performed on the basis of output (amount of electric power) characteristics with respect to a rotation phase, restriction due to the number of photovoltaic cells can be minimized.

According to the present invention, pulsation of electric power can be minimized without providing a smoothing circuit, and a charging circuit, a voltage conversion circuit, or the like.

### BRIEF DESCRIPTION OF THE DRAWINGS

FIG. 1 is a perspective view showing a schematic configuration of a photovoltaic module device according to a first embodiment of the present invention.

FIG. 2 is a view (Part 1) showing a photovoltaic cell column group constituting the photovoltaic module device shown in FIG. 1.

FIG. 3 is a view (Part 2) showing the photovoltaic cell column group constituting the photovoltaic module device shown in FIG. 1.

FIG. 4 is a perspective view showing a schematic configuration of a photovoltaic module device according to a second embodiment of the present invention.

FIG. 5 is a view showing a photovoltaic cell column shown in FIG. 4.

FIG. 6 is a view showing a unit cell shown in FIG. 5.

FIG. 7 is a perspective view showing a schematic configuration of a photovoltaic module device according to a third embodiment of the present invention.

FIG. 8 is a perspective view showing a schematic configuration of a photovoltaic module device according to a fourth embodiment of the present invention.

FIG. 9 is a view showing a unit cell shown in FIG. 8.

FIG. 10 is a perspective view showing a schematic configuration of a photovoltaic module device according to a fifth embodiment of the present invention.

FIG. 11 is a functional block diagram showing a control device shown in FIG. 10.

### DETAILED DESCRIPTION OF THE INVENTION

Hereinafter, embodiments to which the present invention is applied will be described in detail with reference to the drawings.

### First Embodiment

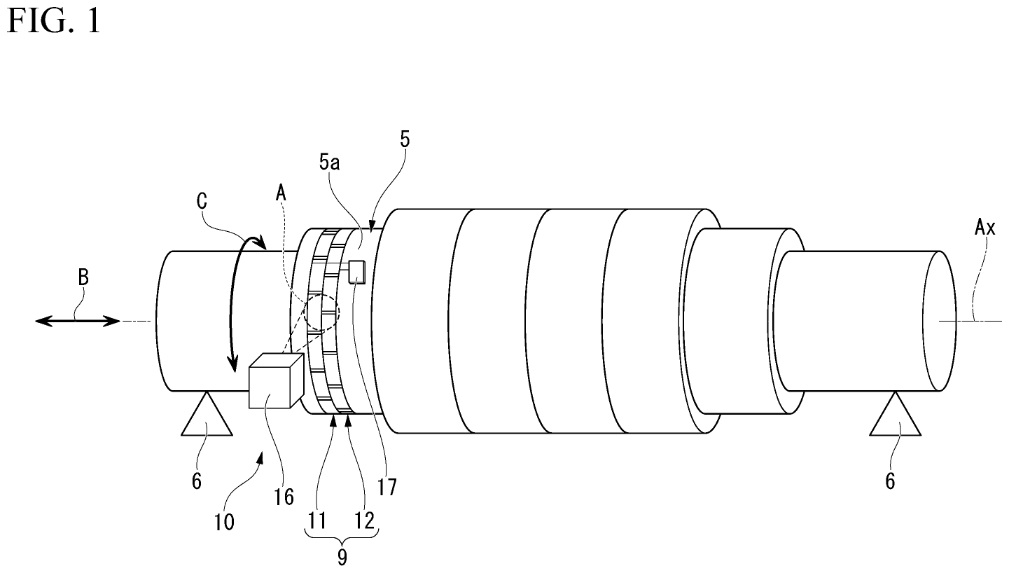

A photovoltaic module device 10 according to a first embodiment of the present invention will be described with reference to FIGS. 1 to 3. In FIG. 1, “A” indicates a region irradiated with light from a first light source 16 (hereinafter, referred to as “light irradiation region A”), “Ax” indicates an axis of a rotating body 5 (hereinafter referred to as “axis Ax”), “B” indicates an axial direction in which the axis Ax extends (hereinafter, referred to as “axial direction B”), and “C” indicates a circumferential direction of the rotating body 5 (hereinafter, referred to as “circumferential direction C”).

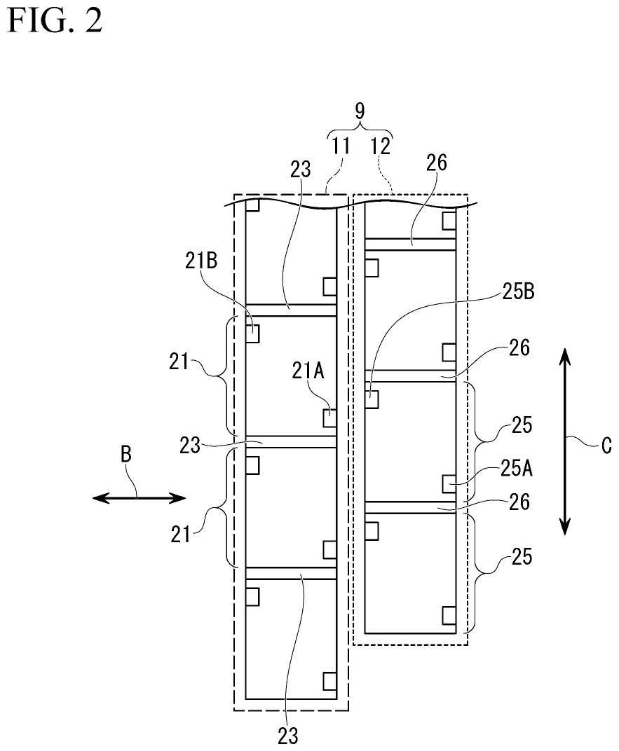

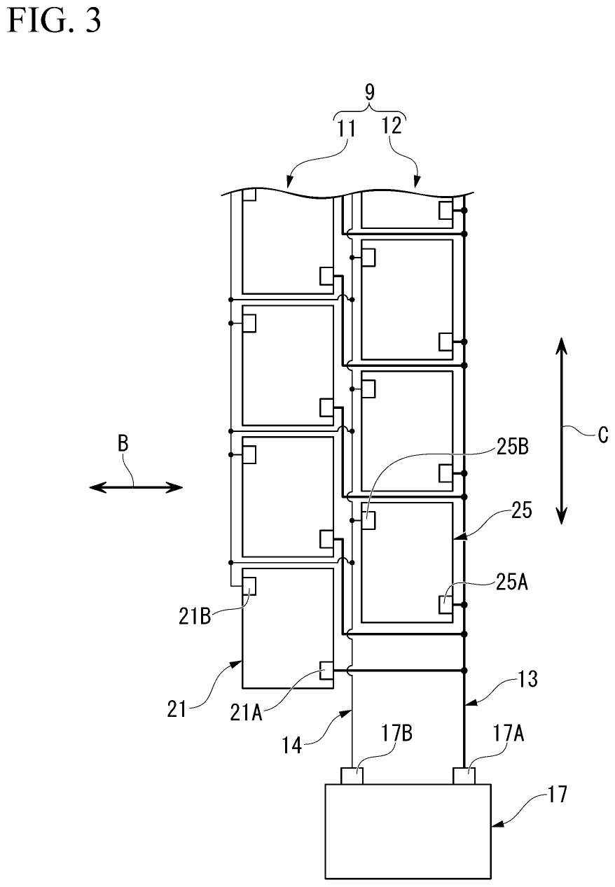

In FIG. 3, illustration of a plurality of seam portions 23 and 26 shown in FIG. 2 is omitted for easier viewing of the drawing. In FIGS. 1 to 3, the same components are denoted by the same references.

The photovoltaic module device 10 includes photovoltaic cell columns 11 and 12 constituting a photovoltaic cell column group 9, a first wiring 13, a second wiring 14, a first light source 16 (light source), and a first target device 17 (target device).

The photovoltaic cell column 11 is installed on an outer circumferential surface 5a of the rotating body 5 that is rotatably supported by a bearing 6. The photovoltaic cell column 11 is disposed in the circumferential direction C of the rotating body 5.

The photovoltaic cell column 11 includes a plurality of photovoltaic cells 21 and a plurality of seam portions 23. The photovoltaic cell column 11 has a configuration in which the photovoltaic cells 21 and the seam portions 23 are alternately disposed in the circumferential direction C.

The photovoltaic cells 21 are cells that generate electric power when they are irradiated with light from the first light source 16. The photovoltaic cells 21 each have a positive terminal 21A and a negative terminal 21B.

Each of the seam portions 23 connects two photovoltaic cells 21 disposed at positions adjacent to each other in the circumferential direction C. The plurality of seam portions 23 are disposed at intervals in the circumferential direction C. The seam portions 23 are portions that do not generate electric power when they are irradiated with light.

The photovoltaic cell column 12 is installed on the outer circumferential surface 5a of the rotating body 5. The photovoltaic cell column 12 is disposed in the circumferential direction C of the rotating body 5.

The photovoltaic cell column 12 is disposed at a position adjacent to the photovoltaic cell column 11 in the axial direction B.

The photovoltaic cell column 12 includes a plurality of photovoltaic cells 25 and a plurality of seam portions 26. The photovoltaic cell column 12 has a configuration in which the photovoltaic cells 25 and the seam portions 26 are alternately disposed in the circumferential direction C.

The photovoltaic cells 25 are cells that generate electric power when they are irradiated with light from the first light source 16. The photovoltaic cells 25 each have a positive terminal 25A and a negative terminal 25B.

As the photovoltaic cell 25, for example, a photovoltaic cell having the same configuration as the photovoltaic cell 21 can be used.

The seam portions 26 are disposed in the circumferential direction C and each connect two photovoltaic cells 25 disposed at positions adjacent to each other. The plurality of seam portions 26 are disposed at intervals in the circumferential direction C. The seam portions 26 are portions that do not generate electric power when they are irradiated with light.

As the seam portion 26, for example, a seam portion having the same configuration as the seam portion 23 can be used.

The seam portions 23 and 26 of the photovoltaic cell columns 11 and 12 are disposed in the axial direction B with positions thereof in the circumferential direction C deviated from each other.

The first wiring 13 is connected to a plurality of positive terminals 21A and 25A constituting the photovoltaic cell columns 11 and 12.

The second wiring 14 is connected to a plurality of negative terminals 21B and 25B constituting the photovoltaic cell columns 11 and 12.

The first and second wirings 13 and 14 configured as described above connect a plurality of photovoltaic cells 21 and 25 in parallel to form a parallel circuit.

The first light source 16 is disposed on a radially outward side of the rotating body 5. The first light source 16 irradiates the photovoltaic cell column group 9 passing through the light irradiation region A with light from a position away from the rotating body 5. The first light source 16 irradiates a partial region of the photovoltaic cell column group 9 with light.

As the first light source 16, for example, a light emitting diode (LED) can be used.

The first target device 17 is fixed to the outer circumferential surface 5a of the rotating body 5. The first target device 17 has a positive terminal 17A and a negative terminal 17B.

The positive terminal 17A is connected to the first wiring 13. Thereby, the positive terminal 17A is electrically connected to the positive terminals 21A and 25A of the plurality of photovoltaic cells 21 and 25.

The negative terminal 17B is connected to the second wiring 14. Thereby, the negative terminal 17B is electrically connected to the negative terminals 21B and 25B of the plurality of photovoltaic cells 21 and 25.

Electric power generated in the photovoltaic cell column group 9 that is irradiated with light by the light source is supplied to the first target device 17 via the first and second wirings 13 and 14. The first target device 17 is driven when a first electric power is supplied.

As the first target device 17, for example, a sensor, an amplifier, a transmitting/receiving unit, or the like that measures a physical quantity such as a rotation speed or a temperature of the rotating body 5 during rotational driving can be exemplified.

According to the photovoltaic module device 10 of the first embodiment, when the seam portions 23 and 26 are disposed in the axial direction B with positions in the circumferential direction C of the seam portions 23 and 26 constituting the photovoltaic cell columns 11 and 12 deviated from each other, a magnitude of pulsation of generated electric power can be reduced compared to a case in which the photovoltaic cell columns 11 and 12 are disposed with the seam portions 23 and 26 aligned in the axial direction B.

Thereby, when a disposition in the circumferential direction C of the seam portions 23 and 26 constituting the photovoltaic cell columns 11 and 12 is changed, pulsation of electric power can easily be minimized without providing a smoothing circuit.

Also, with the above-described configuration, pulsation of electric power can be adjusted to be within a variation range of an operating voltage allowed by the first target device 17 to which the electric power is supplied. Thereby, since a charging circuit for stabilizing electric power is not necessary, a configuration of the photovoltaic module device 10 can be simplified.

In the first embodiment, although the case in which two photovoltaic cell columns (the photovoltaic cell columns 11 and 12) are provided has been described as an example, for example, three or more photovoltaic cell columns having the same configuration as the photovoltaic cell columns 11 and 12 may be provided.

In this case, seam portions of the three photovoltaic cell columns are disposed in the axial direction B with positions thereof in the circumferential direction C deviated from one another.

### Second Embodiment

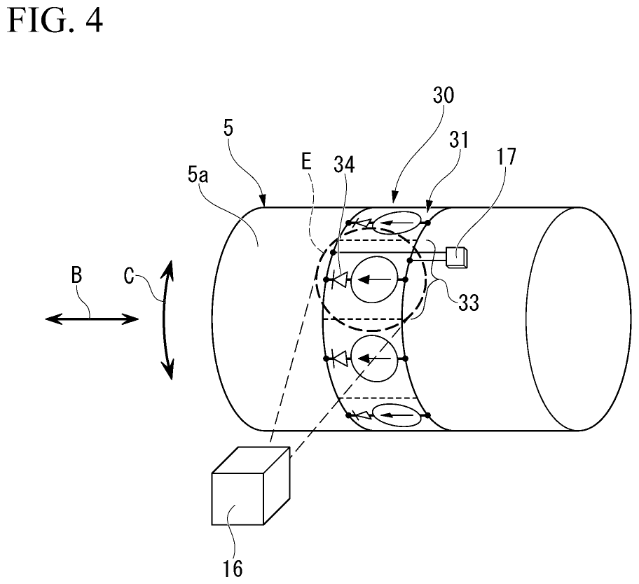

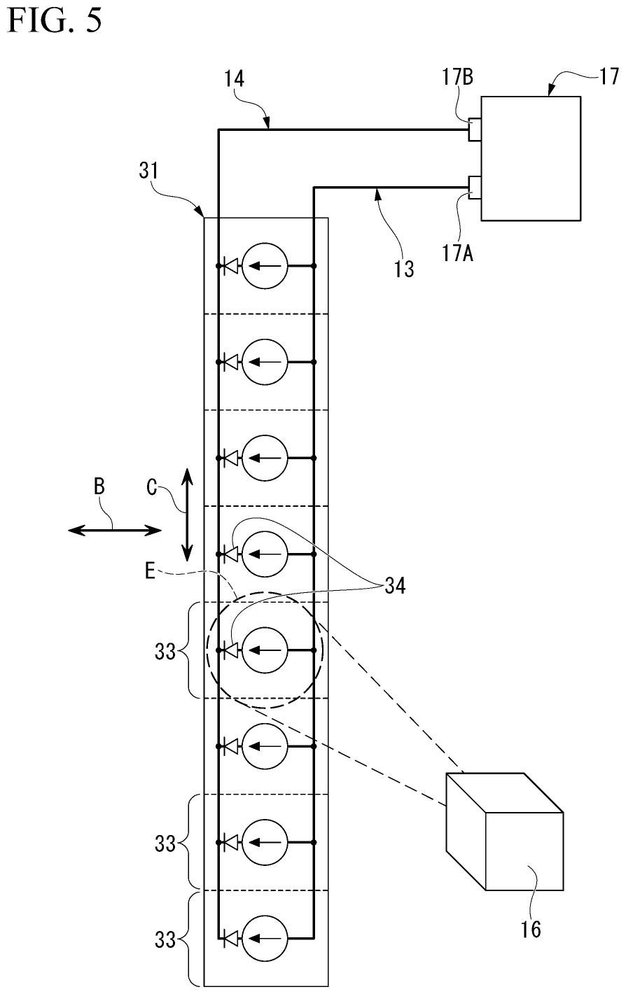

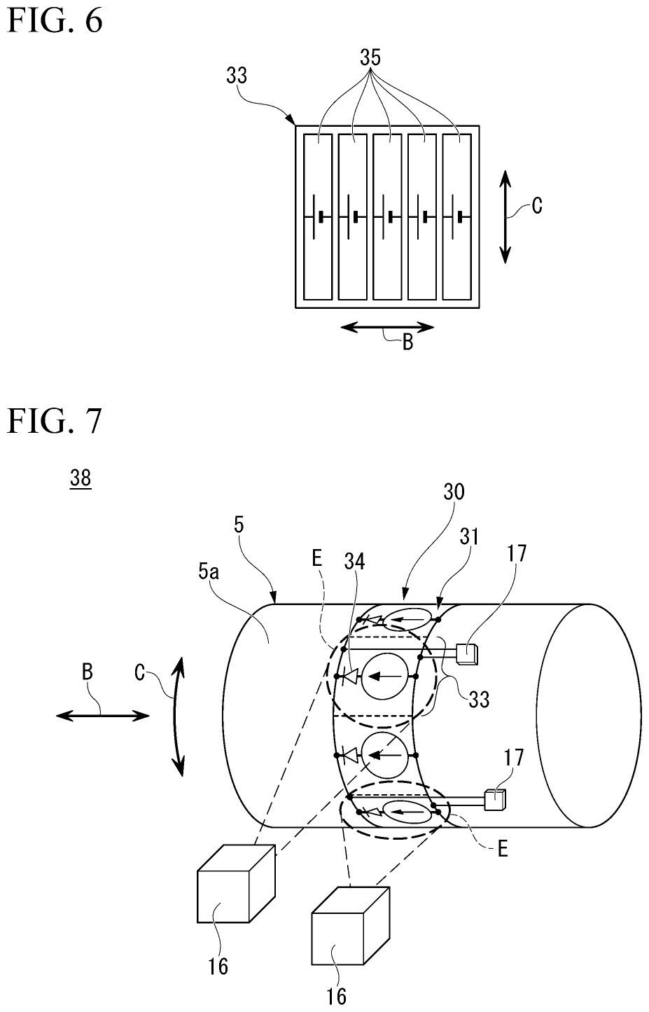

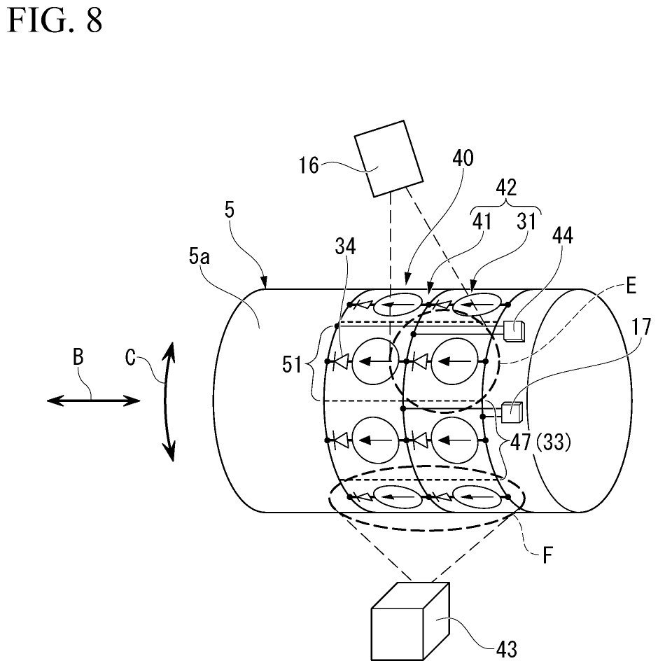

A photovoltaic module device 30 according to a second embodiment will be described with reference to FIGS. 4 to 6. FIG. 4 shows the rotating body 5 shown in FIG. 1 in a simplified manner. In FIGS. 4 and 5, “E” indicates a region irradiated with light from a first light source 16 (hereinafter, referred to as “light irradiation region E”). In FIGS. 4 and 5, components the same as those in the structure shown in FIGS. 1 to 3 are denoted by the same references. In FIG. 6, illustration of a backflow prevention device 34 shown in FIG. 5 is omitted.

The photovoltaic module device 30 has the same configuration as the photovoltaic module device 10 except that a photovoltaic cell column 31 is installed instead of the photovoltaic cell column group 9 constituting the photovoltaic module device 10 of the first embodiment and the light irradiation region E irradiated with light from the first light source 16 is different from the light irradiation region A of the first embodiment.

The photovoltaic cell column 31 is installed on an outer circumferential surface 5a of the rotating body 5. The photovoltaic cell column 31 includes a plurality of unit cells 33. The plurality of unit cells 33 are disposed in a circumferential direction C of the rotating body 5.

The unit cells 33 are each configured by serially disposing the necessary number of photovoltaic cells 35 required to generate a first electric power (amount of electric power) required for a first target device 17.

The unit cell 33 can be constituted by, for example, five photovoltaic cells 35 disposed in series in an axial direction B (see FIG. 6).

As an example, a case in which the unit cell 33 is constituted by five photovoltaic cells 35 is exemplified and shown in FIG. 6, but the number of photovoltaic cells 35 constituting the unit cell 33 can be appropriately set according to a magnitude of electric power required for the first target device 17 and is not limited to five.

The plurality of unit cells 33 are connected to first and second wirings 13 and 14 to form a parallel circuit.

The plurality of unit cells 33 each have a backflow prevention device 34.

As described above, when the plurality of unit cells 33 each have the backflow prevention device 34, electric power generated in one of the unit cells 33 flowing to another one of the unit cells 33 can be inhibited. Thereby, electric power generated in one of the unit cells 33 (electric power with a magnitude corresponding to the first electric power required for the first target device 17) can be efficiently supplied to the first target device 17.

In a state in which the rotating body 5 is rotationally driven, the first light source 16 irradiates only one of the unit cells 33 among the plurality of unit cells 33 with light. That is, the light irradiation region E corresponds to only one of the unit cells 33 among the plurality of unit cells 33.

According to the photovoltaic module device 30 of the second embodiment, the photovoltaic cell column 31 having the plurality of unit cells 33 corresponding to the electric power of the first target device 17 and the first light source 16 that irradiates one of the unit cells 33 rotating together with the rotating body 5 with light are provided, the unit cells 33 are each constituted by the photovoltaic cells 35 disposed in series, and thereby electric power corresponding to the electric power required for the first target device 17 can be stably generated. Thereby, pulsation of electric power can be minimized without providing a smoothing circuit.

Also, since an output voltage does not become a high voltage (a voltage higher than a voltage required for the first target device 17), necessity for a conversion circuit can be minimized.

Also, in a photovoltaic module device according to one aspect of the present invention, a plurality of first target devices having the same operating voltage as each other may be provided as the target device, first light sources of the same number as the number of the first target devices may be provided as the light source, and the first light sources of the same number as the number of the first target devices may irradiate different unit cells of the photovoltaic cell column with light.

With such a configuration, a required drive voltage can be supplied to the respective target devices without increasing the number of photovoltaic cell columns.

### Third Embodiment

A photovoltaic module device 38 according to a third embodiment will be described with reference to FIG. 7. In FIG. 7, components the same as those in the structure shown in FIG. 4 are denoted by the same references.

The photovoltaic module device 38 is configured similarly to the photovoltaic module device 30 except that one first light source 16 and one first target device 17 are further provided in the configuration of the photovoltaic module device 30. That is, the first light sources 16 of the same number as the number of the first target devices 17 are provided.

Of the two first light sources 16, the other of the first light sources 16 irradiates another light irradiation region E disposed at a position different from a light irradiation region E irradiated with light from one of the first light sources 16. The two first target devices 17 are devices having the same operating voltage as each other. Of the two first target devices 17, one of the first target devices 17 is driven by electric power generated when the one of the first light sources 16 irradiates the photovoltaic cell column 31 with light.

Also, the other of the first target devices 17 is driven by electric power generated when the other of the first light sources 16 irradiates the photovoltaic cell column 31 with light.

According to the photovoltaic module device 38 of the third embodiment, when electric power is supplied to the first target devices 17 having the same operating voltage as each other, electric power required for two first target devices 17 can be obtained by adding one first light source 16 without providing another photovoltaic cell column 31.

### Fourth Embodiment

A photovoltaic module device 40 is configured similarly to the photovoltaic module device 30 except that a photovoltaic cell column 41 (second photovoltaic cell column), a second light source 43, a second target device 44 are further provided in the configuration of the photovoltaic module device 30 of the second embodiment.

The photovoltaic cell column 41 constitutes a photovoltaic cell column group 42 together with a photovoltaic cell column 31 (first photovoltaic cell column).

The photovoltaic cell column 31 has a configuration in which a plurality of first unit cells 47 (unit cells 33) are disposed in a circumferential direction C. The first unit cells 47 have the same configuration as the unit cells 33 described above.

The photovoltaic cell column 41 is disposed in the circumferential direction C of a rotating body 5. The photovoltaic cell column 41 has a configuration in which a plurality of second unit cells 51 are disposed in the circumferential direction C. The second unit cells 51 are each disposed at a position adjacent to one of the first unit cells 47 in an axial direction B.

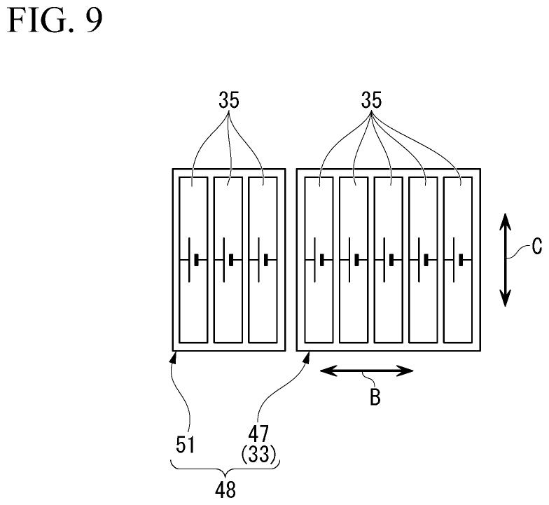

The second unit cell 51 may be constituted by, for example, three photovoltaic cells 35 disposed in series in the axial direction (see FIG. 9).

In FIG. 9, as an exemplary example, a case in which the second unit cell 51 is constituted by three photovoltaic cells 35 is shown, but the number of photovoltaic cells 35 constituting the second unit cell 51 can be appropriately selected and is not limited to three.

One of the first unit cells 47 and one of the second unit cells 51 disposed in the axial direction B constitute one of the third unit cells 48. A plurality of third unit cells 48 are disposed in the circumferential direction C.

When a light irradiation region F is irradiated with light, the third unit cell 48 generates a second electric power required for driving the second target device 44.

The second light source 43 irradiates the light irradiation region F, that is different from a light irradiation region E irradiated with light from a first light source 16, with light.

In a state in which the rotating body 5 is rotationally driven, the second light source 43 is adjusted so that the second target device 44 can be operated by irradiating only one third unit cell 48 among the plurality of third unit cells 48 with light. As the second light source 43, for example, a light emitting diode (LED) can be used.

The second target device 44 is electrically connected to the photovoltaic cell column group 42 in a state in which the second target device 44 can receive electric power generated due to light irradiated from the second light source 43. The second target device 44 is driven at a second operating voltage higher than a first electric power required for a first target device 17.

According to the photovoltaic module device 40 of the fourth embodiment, when the photovoltaic cell columns 31 and 41 and the first and second light sources 16 and 43 having the above-described configurations are provided, necessary electric power can be supplied to the respective first and second target devices 17 and 44 while minimizing pulsation of the electric power without providing a smoothing circuit.

### Fifth Embodiment

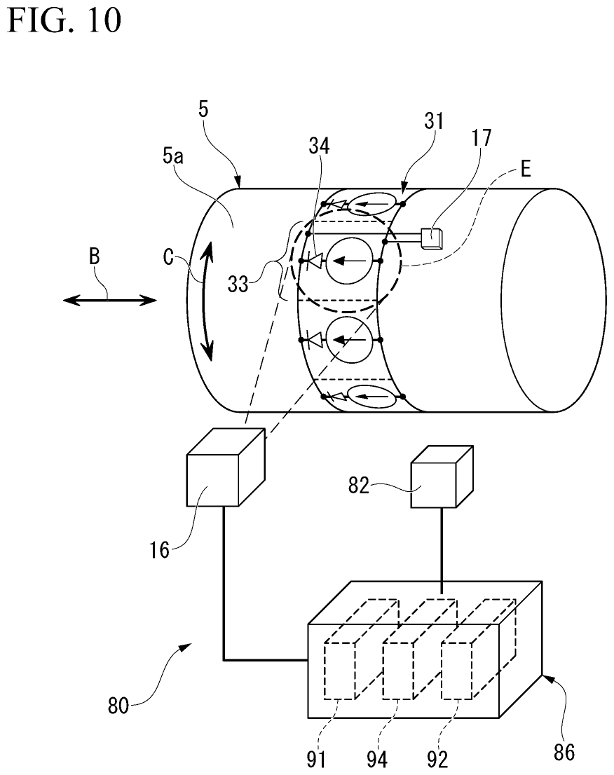

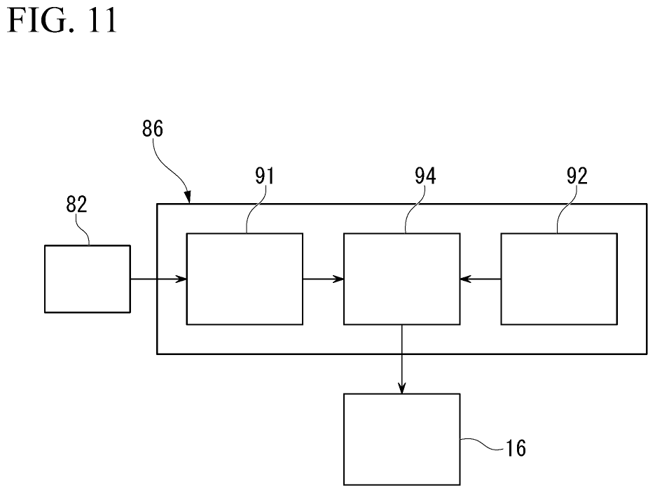

A photovoltaic module device 80 according to a fifth embodiment will be described with reference to FIGS. 10 and 11. In FIG. 10, components the same as those in the structure shown in FIG. 4 are denoted by the same references. In FIGS. 10 and 11, the same components are denoted by the same references.

A photovoltaic module device 80 is configured similarly to the photovoltaic module device 30 except that a tachometer 82 and a control device 86 are further provided in the configuration of the photovoltaic module device 30 of the second embodiment.

The tachometer 82 is electrically connected to the control device 86. The tachometer 82 acquires a pulse signal of a rotating body 5 during rotational driving. The tachometer 82 transmits the acquired pulse signal to the control device 86.

The control device 86 includes an information acquisition unit 91, a storage unit 92, and a light intensity control unit 94.

The information acquisition unit 91 is electrically connected to the light intensity control unit 94. The information acquisition unit 91 acquires rotation speed information and rotation phase information of the rotating body 5 on the basis of the pulse signal transmitted from the tachometer 82. The information acquisition unit 91 transmits the acquired rotation speed information and the rotation phase information to the light intensity control unit 94.

The storage unit 92 is electrically connected to the light intensity control unit 94. The storage unit 92 stores a first data indicating a relationship between an intensity of light irradiated from a first light source 16 and an amount of electric power output from a photovoltaic cell column 31, and a second data indicating a relationship between a rotation phase of the rotating body 5 and an amount of electric power output from the photovoltaic cell column 31.

On the basis of the rotation phase information of the rotating body 5, the first data, and the second data, the light intensity control unit 94 acquires a relationship between an intensity of light of the first light source 16 and a rotation phase of the rotating body 5 and controls an intensity of light irradiated from the first light source 16 so that only an amount of electric power required for the first target device 17 can be acquired.

According to the photovoltaic module device 80 of the fifth embodiment, when the tachometer 82 and the control device 86 described above are provided, an amount of electric power required for the first target device 17 can be obtained without needing an electric power meter all the time.

Also, since the control is performed on the basis of output (amount of electric power) characteristic with respect to a rotation phase, restriction due to the number of photovoltaic cells can be minimized.

While preferred embodiments of the present invention have been described above, the present invention is not limited to such specific embodiments, and various modifications and changes can be made within the gist of the present invention described in the claim.

For example, lengths of the photovoltaic cell columns 11, 12, 31, and 41 disposed in the circumferential direction can be set as appropriate. The lengths of the photovoltaic cell columns 11, 12, 31, and 41 disposed in the circumferential direction, for example, may be half the length of the outer circumferential surface 5a of the rotating body 5 or may be ⅓ length thereof. The first and second light sources 16 and 43 are disposed at optimal positions according to the lengths of the photovoltaic cell columns 11, 12, 31, and 41.

### EXPLANATION OF REFERENCES

5 Rotating body
5a Outer circumferential surface
6 Bearing
9, 42 Photovoltaic cell column group
10, 30, 38, 40, 60, 80 Photovoltaic module device
11, 12, 31, 41 Photovoltaic cell column
13, 65, 68 First wiring
14, 66, 69 Second wiring
16 First light source
17 First target device
17A, 21A, 25A, 44A Positive terminal
17B, 21B, 25B, 44B Negative terminal
21, 25, 35 Photovoltaic cell
23, 26 Seam portion
33 Unit cell
34 Backflow prevention device
43 Second light source
44 Second target device
47 First unit cell
48 Third unit cell
51 Second unit cell
61 First photovoltaic cell group
62 Second photovoltaic cell group
82 Tachometer
84 Electric power meter
86 Control device
91 Information acquisition unit
92 Storage unit
93 Light intensity acquisition unit
94 Light intensity control unit
Ax Axis
A, E, F Light irradiation region
B Axial direction
C Circumferential direction

What is claimed is:

1. A photovoltaic module device which is configured to supply electric power to a target device installed on a rotating body which is rotationally driven, the photovoltaic module device comprising:
a photovoltaic cell column group installed on a circumferential surface of the rotating body; and
a light source fixed at a position away from the rotating body and configured to irradiate the photovoltaic cell column group which is configured to rotate together with the rotating body with light, wherein
the photovoltaic cell column group includes two photovoltaic cell columns which are disposed in a circumferential direction of the rotating body, which are configured by alternately disposing photovoltaic cells and seam portions in the circumferential direction, and in which a plurality of the photovoltaic cells are connected in parallel,
the two photovoltaic cell columns are disposed at positions adjacent to each other in an axial direction of the rotating body, and
the seam portions of the two photovoltaic cell columns are disposed in the axial direction with positions thereof in the circumferential direction deviated from each other.

2. The photovoltaic module device according to claim 1, wherein
the light source is configured to irradiate a partial region of the photovoltaic cell column group with light,
the photovoltaic cell column group is configured to output an operating voltage corresponding to the target device to which electric power is supplied when the partial region thereof is irradiated with light, and
the two photovoltaic cell columns are connected in parallel.

3. The photovoltaic module device according to claim 1, wherein
the photovoltaic cell columns are each constituted by a plurality of unit cells,
the plurality of unit cells are each constituted by a portion of the plurality of photovoltaic cells, and
the plurality of unit cells are disposed in the circumferential direction of the rotating body.

4. The photovoltaic module device according to claim 3, wherein the plurality of unit cells each have a backflow prevention device.

5. The photovoltaic module device according to claim 3, wherein
the target device includes:
a first target device driven by a first electric power; and
a second target device driven by a second electric power different from the first electric power,
the photovoltaic cell column group includes:
a first photovoltaic cell column constituted by a plurality of first unit cells disposed in the circumferential direction; and
a second photovoltaic cell column constituted by a plurality of second unit cells disposed in the circumferential direction and each disposed at a position adjacent to one of the first unit cells in the axial direction of the rotating body, and
the light source includes:
a first light source which is configured to irradiate one of the first unit cells with light; and
a second light source which is configured to irradiate one of third unit cells constituted by one of each of the first and second unit cells in the axial direction of the rotating body with light.

6. A photovoltaic module device which is configured to supply electric power to a target device installed on a rotating body which is rotationally driven, the photovoltaic module device comprising:
a photovoltaic cell column installed on an outer circumferential surface of the rotating body and including a plurality of unit cells; and
a light source fixed at a position away from the rotating body and configured to irradiate the photovoltaic cell column which is configured to rotate together with the rotating body with light, wherein
the photovoltaic cell column is disposed in a circumferential direction of the rotating body,
the unit cells are each configured by serially disposing the necessary number of photovoltaic cells required to generate electric power for driving the target device, and
the light source is configured to irradiate a region corresponding to only one of the unit cells with light.

7. The photovoltaic module device according to claim 6, wherein
a plurality of first target devices having the same operating voltage as each other are provided as the target device,
first light sources of the same number as the number of the first target devices are provided as the light source, and
the first light sources of the same number as the number of the first target devices irradiate different unit cells of the photovoltaic cell column with light.

8. The photovoltaic module device according to claim 6, further comprising:
a tachometer which is configured to acquire a rotation pulse signal of the rotating body during rotational driving;
a storage unit which is configured to store:
a first data indicating a relationship between an intensity of light irradiated from the light source and an amount of electric power output from the photovoltaic cell column; and
a second data indicating a relationship between a rotation phase of the rotating body and an amount of electric power output from the photovoltaic cell column; and
a control device including a light intensity control unit which is configured to control an intensity of light irradiated from the light source on the basis of the rotation phase of the rotating body, the first data, and the second data, wherein
the light intensity control unit is configured to control an intensity of light irradiated from the light source to obtain an amount of electric power required for the target device.
